(19) United States
(12) Patent Application Publication
(10) Pub. No.: US 2006/0099868 A1
(43) Pub. Date: May 11, 2006

(54) Underquilt with multiple layered wool fill

(76) Inventor: Susan L. McCourt, Oconomowoc, WI (US)

Correspondence Address: JAMES EARL LOWE, JR., 15417 W NATIONAL AVE # 300, NEW BERLIN, WI, 53151, US

(21) Appl. No.: 10/982,062

(22) Filed: Nov. 5, 2004

(51) Int. Cl. D04H 13/00; D04H 3/00; B32B 5/26; D04H 1/00

(52) U.S. Cl. 442/352; 442/327; 442/414; 442/381

(57) ABSTRACT

An underquilt with a wool fill including at least two horizontally extending wool layers, each wool layer being a carded layer with the wool fibers lying predominantly in a fiber direction, with the fiber direction of each wool layer being at ninety degrees with respect to its adjacent wool layer. Preferably, there are four layers, and the central two layers do not extend over the outer one-thirds in one direction of the horizontal area of the underquilt.

### FIELD OF INVENTION

The present invention relates to the general field of bedding, and more specifically, to quilts, and especially underquilts.

### BACKGROUND AND PRIOR ART

A quilt is generally defined as a bed coverlet of two layers of cloth, filled with padding, such as down or batting, held in place by ties or stitched designs. Comforters, bedspreads, underquilts and like bed wear have long been used, in addition to normal sleeping usage, to protect other bedding from soil as well as serve a decorative purpose.

The prior art discloses several different types of bed coverings. U.S. Pat. No. 5,855,032 describes a underquilt comprising a fur or synthetic fur lower layer having insulating properties; a fabric upper layer; disposed there between a layer of fill; a first stitching binding the edge of said upper and lower layers together to firm a underquilt; and second stitching binding said upper and lower layers together at intervals throughout the dimensions of said underquilt.

Wool has been used as a fill in underquilts, and is naturally insulating based on its loft, or the amount of air able to be trapped in the wool.

The processing of wool involves shearing, followed by sorting and grading. Once a sheep is shorn, the wool is placed in tall burlap sacks and taken to a wool mill for cleaning and processing. In most parts of the world, sheep are sheared once a year, in early spring or early summer. The best wool comes from the shoulders and sides of the sheep.

This is followed by grading and sorting, where workers remove any stained, damaged or inferior wool from each fleece and sort the rest of the wool according to the quality of the fibers. Wool fibers are judged not only on the basis of their strength but also by their fineness (diameter), length, crimp (waviness) and color.

At the wool mill, the mill workers soak the wool in hot tubs of water and soap. The wool is scoured with detergents to remove the yolk and such impurities as sand and dust. Once it's clean, wool is dried on wire beds. Then it's sent through a carding machine that turns it into fluffy filler for underquilts or into strips called roving. Roving can be dyed before it's turned into yarn. The carding process involves passing the wool through rollers that have thin wire teeth. The teeth untangle the fibers and arrange them into a flat sheet called a web.

Carding is an operation in which fibers like cotton and wool are subjected to the action of surfaces having closely set wire points. This action loosens and partially disentangles the fibers from each other and may be said to be the final stage of the opening out or loosening processes, so that if required the fibers may be readily straightened and arranged in roughly parallel order.

### SUMMARY OF THE INVENTION

This invention is based on a novel concept for an improved underquilt. A multi-layered wool filled underquilt possessing superior insulating and suspension capabilities defines the present invention. More particularly, the underquilt of this invention comprises an underquilt with a wool fill including at least two horizontally extending wool layers, each wool layer being a carded layer with the wool fibers lying predominantly in a fiber direction, with the fiber direction of each wool layer being at ninety degrees with respect to its adjacent wool layer. Preferably, there are four layers, and the central two layers do not extend over the outer one-thirds in one direction of the horizontal area of the underquilt.

Wool has substantial benefits over other known fills. More specifically, wool is organic and pure, and it is hypoallergenic, and this induces relaxation (lowers heart rate). It also insulates well, is dust mite resistant, water resistant and mildew resistant. Wool also is lightweight and provides comfort to Fibromyalgia syndrome sufferers. Wool also helps maintain an optimal body temperature, does not sacrifice the life of an animal, and is appropriate for all climates.

A close-up look at a single fiber of wool looks like a hair covered with scales, like the shingles on a house. Millions of cells make up the scales and are covered with a thin “skin” that is finely porous. This porous quality allows vapors to penetrate, but at the same time, resistant to water droplets. Inside the fiber is a very thirsty center which can absorb up to 30% its own weight without feeling wet and uncomfortable. The end result is a natural material that is capable of absorbing and rapidly evaporating body moisture for a healthy, dry and comfortable warmth. A by-product of this capability to absorb moisture contributes to its flame resistance. Because there is moisture in every fiber, wool is naturally flame resistant. That's why wool blankets can be used to put out small fires.

In addition, each fiber has a natural spring quality with a built-in memory. These springy fibers allow the wool products to return to their original fluffy, soft shape after compression over and over again. That is why wool products outlast other materials and allows for generations of use.

Wool also provides many benefits when compared to other fill materials, as shown in the following chart.

| Benefit | Synthetic/MicroFiber | Goose Down | Cotton | Wool |
|---|---|---|---|---|
| Support & | Smooth fibers do not | A mix of soft | Although they | Has a natural |
| Weight | offer structure nor | feathers, | provide a | resilience |
| Distribution | resist each other | provides more | little more | that is a |
| | when they are | support than | support than | function of |
| | grouped together, | synthetic, | synthetic or | the natural |
| | thus, synthetics | however still | down, the | crimps (or |
| | bottom out when | tends to | support does | springiness) |
| | weight is applied. | bottom out | not last very | found in the |
| | Cannot support | and likewise | long because | fibers and |
| | weight, nor | cannot | fibers break | hair-like |
| | distribute it away | support | and/or matte | scales or |
| | from pressure and | weight nor | down. Here | burrs found |
| | tender points. Fiber | distribute it | too, there is | on each wool |
| | breakage also occurs | away from | no support | fiber. These |
| | over time. | pressure and | and | natural |
| | | tender | distribution | attributes |
| | | points. | of body | create a |
| | | | weight away | weight |
| | | | from pressure | supporting |
| | | | and tender | structure |
| | | | points | with the non- |
| | | | | woven |
| | | | | batting, like |
| | | | | none of the |
| | | | | others! |
| Insulation | Good insulators by | With at least | Breathes well | Wool is as |
| | trapping quite a bit | 85%+ mixture | and is | good as |
| | of area | of feathers | preferred for | micro-fibers |
| | | and plume, is | some | or down, plus |
| | | also a good | applications, | has the added |
| | | insulator. | but not as an | benefit of |
| | | Down and | insulator | breath |
| | | feather fill | | ability, |
| | | have a | | therefore |
| | | tendency to | | wool can |
| | | overheat. | | insulate and |
| | | | | keep you warm |
| | | | | to your exact |
| | | | | body |
| | | | | temperature, |
| | | | | 98.6 F. By |
| | | | | maintaining |
| | | | | your exact |
| | | | | body |
| | | | | temperature, |
| | | | | you will not |
| | | | | overheat |
| | | | | while you are |
| | | | | sleeping. |
| Moisture | Absorb less than 1% | Absorbs some | Absorbs a lot | Wool absorbs |
| Management | of moisture, so | moisture and | of moisture | up to 30% of |
| | moisture from your | becomes a wet | and it too | its weight in |
| | body has to pass | blanket -- | becomes a wet | moisture, but |
| | through your | uncomfortable | blanket -- | does not feel |
| | blankets and | to be in | uncomfortable | clammy. It |
| | mattress or it will | contact with | to be in | dries from |
| | condense as | | contact with | within and as |
| | perspiration. | | | a result of |
| | | | | wool's |
| | | | | special |
| | | | | porous |
| | | | | fibers, |
| | | | | moisture |
| | | | | evaporates |
| | | | | quickly |
| Flame | Almost all synthetic | Somewhat | Somewhat | Safest choice |
| Resistant | fibers are flammable | flame | flame | as shown by |
| | | resistant, | resistant, | its |
| | | because it | because it | institutional |
| | | does absorb | does absorb | use. Because |
| | | some moisture | some | of its unique |
| | | | moisture, but | chemical |
| | | | can kindle if | structure and |
| | | | exposed to | natural |
| | | | fire | moisture |
| | | | consistently | absorption, |
| | | | | difficult to |
| | | | | ignite. Wool |
| | | | | suits are |
| | | | | worn by |
| | | | | racecar |
| | | | | drivers to |
| | | | | protect them |
| | | | | from fire. |

Other features and advantages of the present invention will become apparent from the following detailed description, taken in conjunction with the accompanying figures that illustrate by way of example the principles of the instant invention.

### BRIEF DESCRIPTION OF THE DRAWINGS

FIG. 1 is a perspective view of a bed illustrating the use of the underquilt product of this invention thereon.

FIG. 2 is an exploded view of the fill of the underquilt of this invention, showing the layers of wool in the fill.

FIG. 3 is a sectional view of the underquilt of this invention, illustrating how each wool layer fiber angle is at ninety degrees to its next adjacent layer.

Before one embodiment of the invention is explained in detail, it is to be understood that the invention is not limited in its application to the details of the construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience in reference to the drawings and are not to be construed as limiting terms.

### DETAILED DESCRIPTION OF THE PREFERRED EMBODIMENT

The term “underquilt” as used herein, generically includes any covering of the underquilt type. That is, one that most people would specifically call by the name underquilt, or by any at least partly analogous term such as blanket, comforter, coverlet, lap robe, afghan, bed sheet, bedspread, futon, duvet, sleeping bag, or the like.

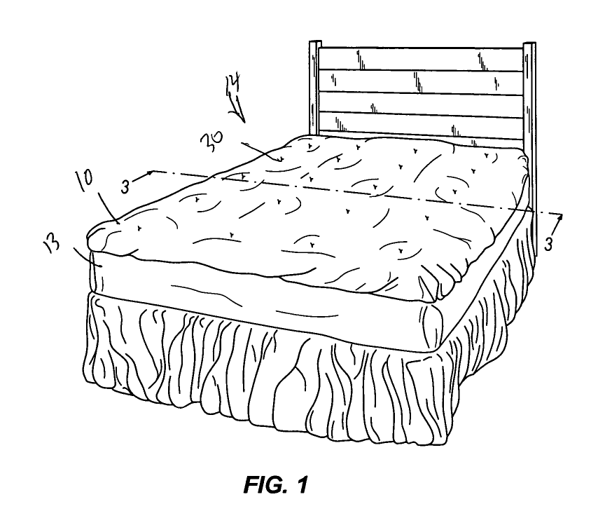

As illustrated in FIGS. 1, 2 and 3, this invention provides an underquilt 10 intended to be used to suspend a person or animal on the underquilt 10 by being placed under the person or animal. In the preferred embodiment, as shown in FIG. 1, the underquilt 10 lies on a conventional mattress 13. The size of the underquilt will correspond to all conventional mattress sizes, including for example, king, queen, double, single and crib. However, size as well as shape may be changed or scaled up or down, accordingly.

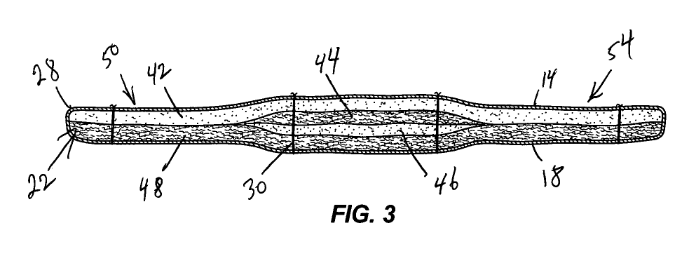

The underquilt 10 disclosed herein is generally rectangular, with a relatively thin upper outer layer or surface 14 (see FIG. 3), a relatively thin lower outer layer or surface 18, and a perimeter comprised of edges 22. However, the actual shape of the invention is not necessarily rectangular in that it may be customized to possess any general shape.

Interposed between the two surfaces 14 and 18 is a wool fill or batting 26 that is suitably secured between the surfaces 14 and 18 through either tying or stitching it in place in a conventional quilting fashion. More specifically, means such as stitches 28 are preferably employed to bind the perimeter edge 22 of said layers together. In the preferred embodiment, the perimeter edges 22 are sown. And means such as stitches or ties 30 at intervals throughout the wool fill 26 are also provided, forming a multiplicity of air insulating cells, pockets or spaces between the layers 14 and 18 and an aesthetically pleasing pattern. The underquilt 10 can be further ornamented or trimmed in any customized fashion to suit the fancy of the maker or user.

More particularly, the upper layer 14 is a decorative knit, woven, non-woven or the like fabric surface utilized as the upper surface when positioned on a bed and the lower layer 18 is a decorative knit, woven, non-woven or the like fabric surface utilized as the under surface when positioned on a bed 14, as shown in FIG. 1. In the preferred embodiment, the upper and lower layers 14 and 18 are made of cotton.

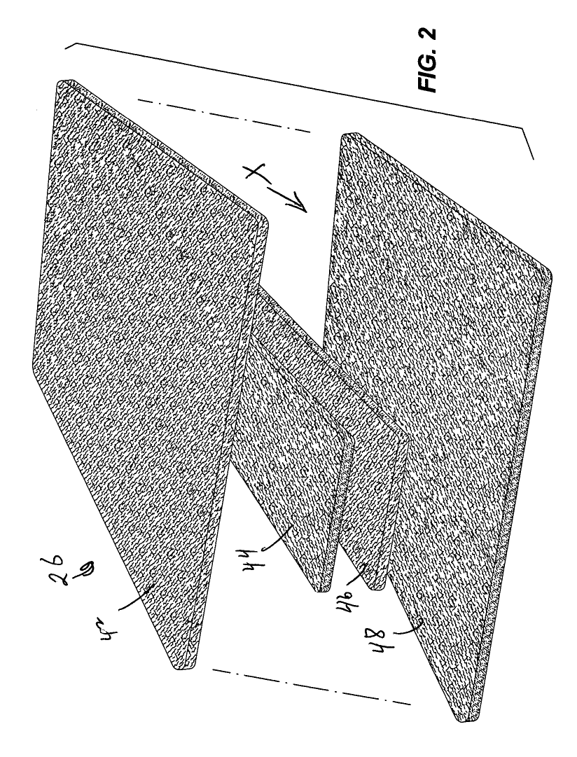

As is seen more specifically in FIGS. 2 and 3, the wool fill 26 comprises a plurality of layers. The layers are held together and reinforced by the ties 30 penetrating there through and arranged, for example, in closely spaced-apart, parallel, exposed rows of ties on the upper surface 14 of the underquilt 10 which extend in generally the lengthwise direction thereof, thus providing strength and stability thereto.

More particularly, the ties 30 are acrylic fibers referred to as tufting that extends from the upper surface 14 through the wool core and into the lower surface 18. In the preferred embodiment, the fiber passes through the lower surface 18 and then reenters the lower surface 18 at an adjacent point. In other embodiments (not shown), the fiber can terminate within the thickness of the lower surface 18 without extending to and beyond the exposed surface of such lower layer 18.

Still more particularly, the wool fill 26 comprises at least two horizontally extending wool layers, each wool layer being a carded layer with the wool fibers lying predominantly in a fiber direction, with the fiber direction of each wool layer being at ninety degrees with respect to its adjacent wool layer. In a carded layer, a multiplicity of the fibers will lie at an acute angle to each other in crossed relationship as a result of the carding operation, and the fibers will be oriented predominantly in a direction extending longitudinally of the carded web. This direction is referred to herein as the fiber direction. In the preferred embodiment, there are four layers 42, 44, 46 and 48, and the central two layers 44 and 46 do not extend over the outer one-thirds 50 and 54 in the direction X (see FIG. 2) of the horizontal area of the underquilt 10, as shown in FIG. 2. This structure provides additional loft in the underquilt in the area where the user is most often located.

Further, in the preferred embodiment, each wool layer is made of wool that has been washed or dusted at least twice. This is important for it removes any particles that may be uncomfortable to the person or animal lying on the underquilt 10. It is also important in the preferred embodiment that the wool be short and crimpy wool, such as a Dorset or Hampshire wool, and most preferably a Texas lamb wool. Further, in the preferred embodiment, each of the wool layers is made from between three to four pound bats.

While specific embodiments of the invention have been illustrated and described herein, these should not be construed as limitations on the scope of the invention, but rather an exemplification of the preferred embodiments thereof. Numerous variations are possible and will occur to those skilled in the art. It is therefore to be understood that the appended claims are intended to cover all such modifications and changes as fall within the true spirit and scope of the invention.

1. An underquilt comprising a lower layer, an upper layer, a wool fill between said lower layer and said upper layer; said lower layer and said upper layer including respective edges, said adjacent edges of each of said upper and lower layers being attached to each other, and tufting that secures said upper and lower layers together at intervals throughout the dimensions of said underquilt,
said wool fill further comprising at least two horizontally extending wool layers, each wool layer being a carded layer with the wool fibers lying predominantly in a fiber direction, with the fiber direction of each wool layer being at ninety degrees with respect to its adjacent wool layer.

2. An underquilt in accordance with claim 1 wherein said edges are sown.

3. An underquilt in accordance with claim 1 wherein each wool layer is made of wool that has been washed at least twice.

4. An underquilt in accordance with claim 1 wherein said wool is short and crimpy wool.

5. An underquilt in accordance with claim 4 wherein said wool is Dorset wool.

6. An underquilt in accordance with claim 4 wherein said wool is Hampshire wool.

7. An underquilt in accordance with claim 4 wherein said wool is Texas lamb wool.

8. An underquilt in accordance with claim 1 wherein each of said wool layers is made from between three to four pound bats.

9. An underquilt comprising a lower layer, an upper layer, a wool fill between said lower layer and said upper layer; said lower layer and said upper layer including respective edges, said adjacent edges of each of said upper and lower layers being attached to each other, and tufting that secures said upper and lower layers together at intervals throughout the dimensions of said underquilt,
said wool fill further comprising at least four horizontally extending wool layers, each wool layer being a carded layer with the wool fibers lying predominantly in a fiber direction, with the fiber direction of each wool layer being at ninety degrees with respect to its adjacent wool layer.

10. An underquilt comprising a lower layer, an upper layer, a wool fill between said lower layer and said upper layer; said lower layer and said upper layer including respective edges, said adjacent edges of each of said upper and lower layers being attached to each other, and tufting that secures said upper and lower layers together at intervals throughout the dimensions of said underquilt,
said wool fill further comprising at least four horizontally extending wool layers, each wool layer being a carded layer with the wool fibers lying predominantly in a fiber direction, with the fiber direction of each wool layer being at ninety degrees with respect to its adjacent wool layer, said central two layers not extending over the outer one-thirds in one direction of the horizontal area of the underquilt.

11. An underquilt in accordance with claim 10 wherein said edges are sown.

12. An underquilt in accordance with claim 10 wherein each wool layer is made of wool that has been washed at least twice.

13. An underquilt in accordance with claim 10 wherein said wool is short and crimpy wool.

14. An underquilt in accordance with claim 13 wherein said wool is Dorset wool.

15. An underquilt in accordance with claim 13 wherein said wool is Hampshire wool.

16. An underquilt in accordance with claim 13 wherein said wool is Texas lamb wool.

17. An underquilt in accordance with claim 10 wherein each of said wool layers is made from between three to four pound bats.
